(19) United States
(12) Patent Application Publication
(10) Pub. No.: US 2004/0134386 A1
(43) Pub. Date: Jul. 15, 2004

(54) Refractory material

(75) Inventors: Shun-Chi Chang, Taipei (TW); Chin-Hung Wu, Chungli City (TW)

Correspondence Address: BACON & THOMAS, PLLC, 625 SLATERS LANE, FOURTH FLOOR, ALEXANDRIA, VA, 22314

(73) Assignee: FREEDOM GROUP LTD., Apia (WS)

(21) Appl. No.: 10/342,365

(22) Filed: Jan. 15, 2003

(51) Int. Cl. C04B 38/00; C04B 7/00; C04B 16/00; C04B 16/02; C04B 24/00; C04B 14/00

(52) U.S. Cl. 106/805; 106/731; 106/737

(57) ABSTRACT

A refractory material is made of plant fibers, refractory granules, and inorganic cement materials in a predetermined proportion, wherein the refractory granules are evenly mixed with the inorganic cement materials, so that it can penetrate between the plant fibers and cover the surface of the plant fiber, the refractory property of the porous refractory granule can effectively strengthen the refractory capability of the inorganic cement material and plant fiber, so that the mixture can stand a burning temperature higher than traditional partition materials, the plant fibers are evenly mixed to effectively enhance the tenacity of the partition material such that the partition material can stand a high-temperature burning for a long time and will not crack into pieces or powder easily.

### BACKGROUND OF THE INVENTION

1. Field of the Invention

The present invention relates to a refractory material, more particularly to a refractory material composed of fibers, granules, and inorganic cements in a predetermined portion.

2. Description of the Related Art

In recent years, as the population continues to grow, regardless of the design of commercial of residential buildings in cities and towns of different countries in the world, the buildings tend to develop in a vertically upward direction, and expect to create more room for offices and homes. Therefore, skyscrapers and tall buildings are all over the places in cities and towns, not only changing the landscape and the ecological environment, but also changing the habits of our life.

People growing up in a metropolitan not only resides or works in tall buildings, but also spends their leisure time for entertainment in the building. Therefore, safety becomes an eye-catching issue to buildings as time has changed. Among these, the issues of quake prevention and fire control are the most important ones. Traditionally, when constructing a building, it generally uses bricks or steel bars or cement as construction materials, and some directly use steel frame as the main structure. After the construction of the main structure is completed, bricks or plaster of Paris cast are used to partition each floor, and among these partition materials, brick has the firm and solid features, but is heavier, which results an increase in the overall burden of the building. Although the plaster of Paris cast is lighter, but its structure is weaker, so that the building is unable to stand larger impact or vibration, particularly when there is a fire accident to the building. Such traditional partition materials are unable to stand the long time of burning, but continue to burn easily due to the high temperature. It deteriorates the molecular structure of the material and cracks into pieces or powder, and thus loses its originally intended applications for the support and partition. After a fire has started, it will be out of control and become irremediable, or even cause serious damages to our property and life. With no surprise, such familiar scenes can be seen very often in television news.

Although there have been numerous studies on the causes for a building to catch fire and its continuation of burning, the most important and essential reason relies on that the traditional partition materials are unable to effectively isolate the fire source. Thus, it causes the fire to continue burning, and spread out that makes the fire extinguishing more difficult. Therefore, it is an important subject for the present construction material industry and researchers to find a way of making partition materials strong and light, with refractory and heat insulating features, so that the partition material will not continue to burn at high temperature, or cause deteriorations or powering and cracking phenomenon to the material.

### SUMMARY OF THE INVENTION

In view of the shortcomings of the traditional partition materials such as bricks and plasters of Paris cast, the inventor of the present invention based on years of experience accumulated from the engagement in the related industry conducted extensive research to resolve the aforementioned shortcomings and invented the refractory material in accordance with the present invention. The structure of the refractory material comprises a plant fiber in a specific length (such as wood wool or coconut shell fiber, and the like), individually mixed with inorganic cement materials (such as cements and the like) and porous refractory granules (such as the high-temperature sintered silicates mineral powder and the like) in a specific percentage by weight, and appropriate quantity of water is added to mix them until the inorganic cement materials, refractory granules, and plant fibers are evenly mixed and the inorganic cement materials and the refractory granules are evenly penetrated between the plant fibers and cover the surface of the plant fiber. Such mixture is poured into a mold, and then the refractory material of the present invention is produced with high-pressure formation and drying processes.

The primary objective of the present invention is to provide a refractory material produced by mixing refractory granules evenly with inorganic cement materials and allowing the refractory granules to penetrate between the plant fiber and covering the surface of the plant fiber, such that the refractory and heat-insulating properties of the porous refractory granule can effectively strengthen the refractory and heat-insulating capability of the inorganic cement material and plant fiber and stand a burning temperature higher than traditional partition materials.

A secondary objective of the present invention is to provide a refractory material produced by interlacing the plant fibers evenly in the mixing process to effectively enhance the tenacity of the partition material such that the partition material can stand the high-temperature burning for a long time and will not crack into pieces or powder easily.

Another object of the present invention is to provide a refractory material containing plant fibers and porous refractory granules with the light weight feature, as well as the rough and coarse porous surface feature, so that such material can be mixed evenly with the inorganic cement material to produce a stronger link between the molecules of the material and a light and tenacious refractory material.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of the manufacturing flow of the refractory material of the present invention.

FIG. 2 is a diagram of the temperature rise graph of indoor burning test for the refractory material of the present invention according to the national standard CNS12514 and CNS6532 specifications.

FIG. 3 is a diagram of the temperature rise graph of indoor burning test for the external lateral surface of the refractory material of the present invention according to the national standard CNS12514 and CNS6532 specifications.

### DETAILED DESCRIPTION OF THE PREFERRED EMBODIMENTS

The present invention discloses a refractory material comprising a plant fiber of specific length and mixed with an inorganic cement material and a porous refractory granule in a predetermined proportion (in percentage by weight), and water in a predetermined proportion (in percentage by weight) is added to mix with the mixture until the inorganic cement material, refractory granules, and plant fibers are evenly mixed, and the inorganic cement material and refractory granules penetrate between the plant fibers evenly, and cover the surface of the plant fiber. The mixture is then poured into a mold to produce the refractory brick by the high-temperature formation and drying processes. In the refractory material of the present invention, the plant fiber comes from natural botanic fibers, which could be a plant fiber with long striped fiber such as wood wool, coconut shell, straw, or palm, so that these plant fibers can be evenly distributed and interlaced with each other during the mixing process. The refractory granule comes from natural minerals; porous granules are formed after the crushing process and high-temperature of burning and sintering process at over 1000° C., and the typical examples are the materials such as the infusorial earth, silica, or white carbon sold in the market. Since the major constituent of these materials is silicon dioxide, therefore after high-temperature burning and sintering, such materials will have a superior refractory property. The inorganic cement material could be Portland cement, silicate inorganic (also known as water glass), or the combination of the above. The main purpose of using inorganic cement materials is to give an even mixture of plant fibers and refractory granules; after the high-temperature formation and drying processes, the inorganic cement material solidifies with the plant fibers and refractory granules. Since the materials used by this invention come from the natural and easily obtainable plant fibers and minerals, therefore the refractory material so produced can meet the requirements of the environmental protection without increasing the production cost.

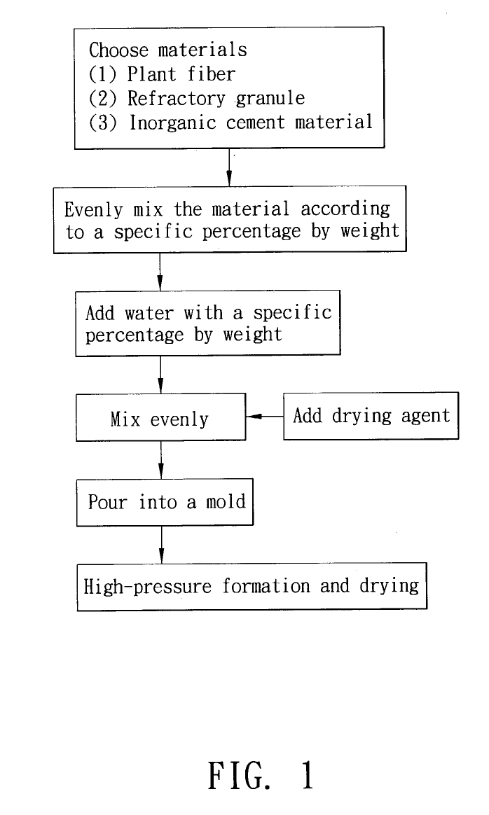

Please refer to FIG. 1 for the manufacturing flow of the refractory material in accordance with a preferred embodiment of the present invention. The plant fiber used is the wood wool fiber, and such fiber is about 0.7˜6 mm long, 0.1˜0.6 mm thick, and substantially in stripes. After the antiseptic treatment, the manufactured wood wool will be at least 3 cm long, and it is preferred to be 5˜17 cm. The refractory granule used is the common silica sold in the market, and the diameter of the sieved granule falls in the range of 4 μm˜6 mm. The inorganic cement material used is the Portland cement sold in the market, and these materials are mixed evenly with the following proportions (in percentages) by weight.

(1) Plant fiber: 15%˜30%;

(2) Refractory granule: 10%˜35%,

(3) Inorganic cement material: 45%˜70%;

In the aforementioned mixture, water of 40%˜60% by weight is added and mixed to the mixture. The inorganic cement material, refractory granule, and plant fiber must be fixed evenly, and the inorganic cement material and the refractory granule have to penetrate between the plant fibers, and cover the surface of the plant fiber. Finally, the aforementioned mixture is poured into a mold with predetermined shape and form. The refractory material of the present invention can be produced after the high-pressure formation and drying processes.

Please refer to FIG. 1 again. The preferred embodiment of the present invention intends to expedite the solidification of plant fibers and refractory granules in the high-pressure formation and drying processes of the inorganic cement material by adding appropriate proportion (percentage by weight) of the solidifying agent to shorten the time required for the manufacturing and production.

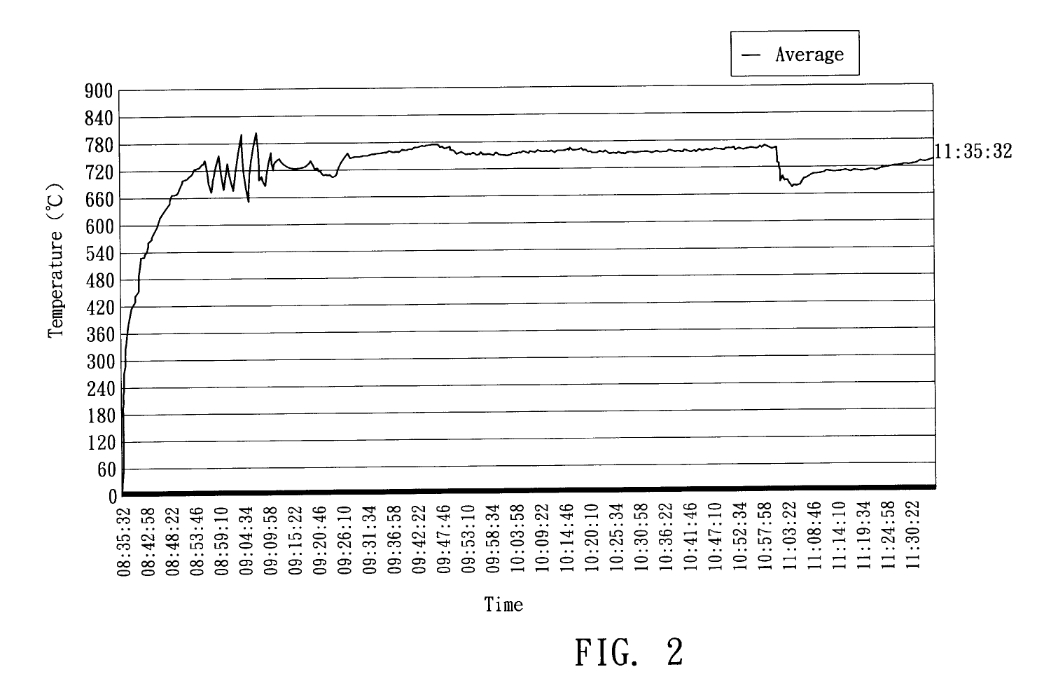

Please refer to FIG. 2. When the production of the refractory material is completed, the refractory granules in the structure is mixed evenly with the inorganic cement material, penetrating between the plant fibers and covering the surface of the plant fiber. As previously described, since the porous refractory granule itself has an excellent refractory property, therefore it can effectively improve the refractory and heat insulating capability of the inorganic cement material and the plant fiber, so that they can stand the burning and sintering temperature higher than the traditional partition materials. Further, in the manufacturing process described above, the plant fiber can be interlaced with each other in the mixing process due to its long striped fibers, and evenly mixed in the partition material to effectively increase the tenacity of the partition material. Even in the high-temperature burning for a long time, such partition material will not crack into pieces or powder easily.

In addition, since the plant fiber and porous refractory granule is light in weight and their surface is porous, rough, and coarse, therefore they can be evenly mixed with the inorganic cement material. After the high-pressure formation and drying processes, the refractory material so produced definitely possesses the light but tenacious properties.

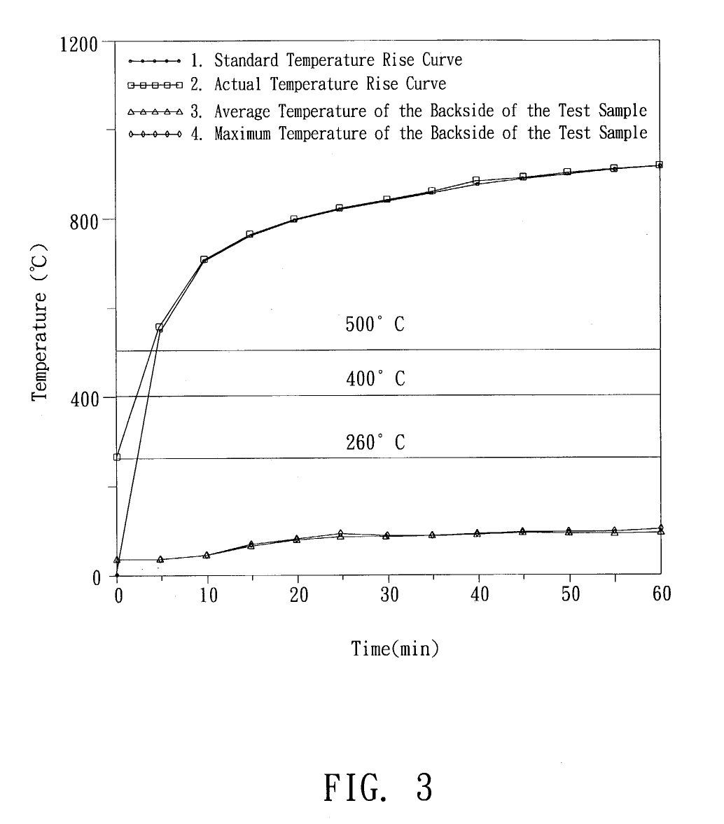

Take the refractory material produced by the present invention for example. A refractory brick of 20 cm long, 20 cm wide, and 5 cm thick has a weight of only 0.9 kg with about 1.8% water content. Such refractory brick is embedded into a sidewall of a close combustion chamber and one side of the brick faces the interior of the combustion chamber and the other side faces the outside of the combustion chamber. A test of the refractory property on the internal side of the brick is performed according to the national standard CNS12514 and CNS6532 specifications. The combustion chamber uses diesel as fuel, and the temperature after burning for 15 minutes reaches 725° C. The temperature rise graph of the combustion chamber is shown in FIG. 3. After burning for 3 hours, the refractory brick of the present invention did not crack into pieces and powder or have the passing-through phenomenon. The maximum temperature detected on the external side (that is the backside) of the brick is only 85° C. and its temperature rise graph is shown in FIG. 3. For a refractory brick of only 5 cm thick, the refractory and heat insulating effect is excellent, and such brick is considered as an excellent refractory material, which is incomparable by traditional partition materials. What is more, such refractory brick did not produce any toxic gas during the 3-hour burning process, and its compressive strength tested according to the national standard CNS1010 specification shows a number as high as 151.75 kg/m². It shows that the brick still maintains an excellent compressive strength after the burning.

What is claimed is:

1. A refractory material, comprising a predetermined percentage by weight of an even mixture of the following composites:
a striped plant fiber;
a porous refractory granule;
an inorganic cement material;
said composites being mixed with water and poured into a mold, and made as a refractory material by high-pressure formation and drying processes, wherein the inorganic cement material, refractory granule, and plant fiber are evenly distributed inside the refractory material, and the inorganic cement material and refractory granule evenly penetrated between the plant fibers, and covering the surface of plant fiber.

2. The refractory material of claim 1, wherein said plant fiber is 15%˜30% of the refractory material by weight.

3. The refractory material of claim 2, wherein said plant fiber is a long striped plant fiber capable of interlacing and coupling with each other in the processing of mixing the plant fiber evenly, and being distributed evenly inside the refractory material.

4. The refractory material of claim 3, wherein said plant fiber is in the shape of a stripe of at least 3 centimeters long.

5. The refractory material of claim 1, wherein said refractory granule is 10%˜35% of the refractory material by weight.

6. The refractory material of claim 5, wherein said refractory granule is a mineral composed primarily of silicon dioxide, forming a porous refractory granule being shattered and sintered.

7. The refractory material of claim 6, wherein said refractory granule has a diameter falling in the range of 4 micrometers to 6 millimeters.

8. The refractory material of claim 1, wherein said inorganic cement material is 45%˜70% of the refractory material by weight.
